(19) United States
(12) Patent Application Publication
(10) Pub. No.: US 2024/0271761 A1
(43) Pub. Date: Aug. 15, 2024

(54) MODULAR HYDROGEN STORAGE SYSTEM

(71) Applicant: HYZON MOTORS USA INC., Bolingbrook, IL (US)

(72) Inventors: Richard Daniel Warlick, JR., Troy, MI (US); George He, Troy, MI (US)

(21) Appl. No.: 18/435,496

(22) Filed: Feb. 7, 2024

Related U.S. Application Data
(60) Provisional application No. 63/483,663, filed on Feb. 7, 2023.

(51) Int. Cl. F17C 13/12

(52) U.S. Cl. CPC F17C 13/123; F17C 2205/0107; F17C 2205/013; F17C 2205/0169; F17C 2205/0192; F17C 2221/012; F17C 2270/0171

(57) ABSTRACT

A modular design for a storage tank system can be deployed across multiple vehicle platforms. Certain embodiments can include a rack. The rack can be configured to hold a storage tank. The rack can include a frame assembly. The frame assembly can include a base, an upright support member, and a strap connected to the frame assembly, where the strap can be configured to secure the storage tank on the frame assembly. In some embodiments, the base includes a Y-axis support member and an X-axis support member. The storage tank can sit across the Y-axis support member in a secured configuration. The rack can be configured to removably mount to a platform of a vehicle.

### CROSS-REFERENCE TO RELATED APPLICATIONS

This application claims the benefit of U.S. Provisional Application No. 63/483,663, filed on Feb. 7, 2023. The entire disclosure of the above application is incorporated herein by reference.

### FIELD

The present technology includes articles of manufacture and processes that relate to a hydrogen storage system that holds multiple hydrogen tank storage racks.

### INTRODUCTION

This section provides background information related to the present disclosure which is not necessarily prior art.

Hydrogen fuel cell applications have great potential to drive the future of mobility. Regions such as the U.S., China, Europe, and Japan, among others are recognizing this trend and focusing policy efforts on developing fuel cell technology, supply chain, and infrastructure on multiple fronts. Fuel cells for transportation can include a wide range of use cases. Findings suggest that fuel cell technologies can be ideal for a decarbonization of heavy duty and/or long-range transport applications. These segments can include heavy-duty and medium-duty trucks, delivery vans, large passenger vehicles with long-ranges, and long-distance coaches. Studies of fuel cell powered trucks suggest that this technology can be a low cost way to decarbonize both the medium-duty and the heavy-duty segments.

While fuel cells have become an important renewable energy option, fuel cell technology is still developing, and there are numerous key areas in which fuel cell technology can improve including fuel cell efficiency, lifespan, and manufacturing costs. Other areas for improvement relate to the design of the on-board hydrogen storage system and the hydrogen fuel itself from which the fuel cells generate power.

A hydrogen tank can occupy a large volume when mounted on a vehicle platform. In addition, due to stringent design requirements, manufacturing and assembling a robust hydrogen storage system can be costly, bulky (volumetrically), and heavy. For example, a welded storage rack design can be strong, but labor intensive to manufacture, assemble, and mount onto a vehicle platform.

Accordingly, there is a need for a hydrogen storage system that is lighter weight, modular, adaptable to multiple different vehicle platforms and that can be scaled to fit both larger and smaller pressure vehicles.

### SUMMARY

In concordance with the instant disclosure, a hydrogen storage system that is lighter weight, modular, adaptable to multiple different vehicle platforms, and that can be scaled to fit both larger and smaller pressure vehicles, has surprisingly been discovered.

The present technology relates to a rack system for holding storage tanks, such as those used for hydrogen storage. The system is adaptable for mounting on various vehicle platforms and can hold multiple storage tanks. The rack comprises a frame assembly with a base that includes Y-axis and X-axis support members. A strap connected to the frame assembly secures the storage tank, which sits across the Y-axis support member when secured.

In one embodiment, a rack designed to hold a storage tank includes a frame assembly with a base, an upright support member, and a strap that is connected to the frame assembly. The strap is specifically configured to secure the storage tank on the frame assembly. Additionally, the base of the frame assembly is equipped with a y-axis support member and an x-axis support member, arranged so that the storage tank is positioned across the y-axis support member and secured in place.

In another embodiment, a system for holding multiple storage tanks. This system includes a first rack and a second rack, each designed to hold a storage tank. Both racks include a frame assembly that features a base, an upright support member, and a strap connected to the frame assembly. The strap can secure the storage tank on the frame assembly. The base of each rack incorporates a y-axis support member and an x-axis support member, which support the storage tank when the strap secures it in place. The second rack is connected on top of the first rack, allowing the two racks to be connected in a stacked configuration.

In yet another embodiment, a vehicle includes a body with a rack platform mounted thereon. The vehicle can accommodate the rack for a storage tank, which is removably received onto the rack platform. The rack includes a frame assembly with a base, an upright support member, and a strap connected to the frame assembly. The strap is intended to secure the storage tank on the frame assembly. The base is designed with a y-axis support member and an x-axis support member, which support the storage tank in a secured configuration.

In a further embodiment, a method of using a rack for a storage tank is provided. This method involves providing the rack, which includes a frame assembly with a base, an upright support member, and a strap connected to the frame assembly. The strap is designed to secure the storage tank on the frame assembly. The base further includes a y-axis support member and an x-axis support member, which support the storage tank in a secured configuration. The method includes determining the hydrogen fuel needs for a vehicle, determining the optimum number of racks needed to hold the corresponding number of storage tanks based on the fuel needs, loading the storage tanks onto each rack, securing the storage tanks to the rack, assembling the racks in a stacked configuration to form a hydrogen storage system, positioning the assembled hydrogen storage system onto the vehicle, and securing the hydrogen storage system to the vehicle.

The upright support member features an alignment peg and an adapter bracket, enabling the removable connection of additional racks in a stacked configuration. This design permits the rack to be mounted removably to a rack platform of a vehicle. The Y-axis support member includes a form-fitting slot for the storage tank, and the strap is connected to the Y-axis support member on both sides, securing the tank. The frame assembly is designed to hold multiple storage tanks, with some configurations capable of holding two tanks, each secured by a strap.

The system for holding multiple storage tanks can use multiple racks, such as a first rack and a second rack. The second rack can be positioned on top of the first rack, creating a stacked configuration. One of these racks is designed to be removably mounted to a vehicle platform. The system allows for the alignment peg of the first rack to fit removably into the adapter bracket of the second rack, connecting the two racks in the stacked configuration. The system can accommodate any desired number of racks in this arrangement.

The system can also include a vehicle with a body that comprises a semi-truck body, including a cab and a bed, and a plurality of wheels. A rack platform mounted to the body can receive a rack configured to hold a storage tank. The rack includes a frame assembly with a base, an upright support member, and a strap to secure the storage tank.

The system can further include a method for using a rack to hold a storage tank. The method involves providing a rack with a frame assembly that includes a base, an upright support member, and a strap for securing the tank. The base can further include Y-axis and X-axis support members, across which the tank is positioned. The method can also include mounting the rack onto a vehicle.

With this modular system, a manufacturer can fabricate a common base or base frame design repetitively, allowing for manufacturing optimization and cost reductions. The system can be mounted to a vehicle, such as a semi-truck platform using adapter brackets. When used on a different vehicle platform, a new adapter bracket can be created for the existing cradle sub-systems.

The modular configuration allows deployment across many vehicle platforms and is scalable, with the ability to add or subtract storage racks as needed. The design can adapt to larger and smaller pressure vessels by adjusting the system volume with different numbers of tanks. The modular sub-system approach can reduce costs, minimize shipping costs, and reduce overall mass during vehicle integration. The design also facilitates swapping out storage racks with full tanks for those with empty or partially empty tanks, optimizing vehicle refueling.

The present technology is directed to a modular hydrogen storage system designed to improve hydrogen fuel storage across various vehicle platforms. The system is based on a modular rack that holds hydrogen storage tanks using a frame assembly that includes a base, upright support members, and straps for securing the tanks. The base features Y-axis and X-axis support members to accommodate the tanks. This modular approach allows for the racks to be easily configured in a stacked arrangement, facilitating scalability in storage capacity and adaptability to different vehicle sizes and designs. The modularity also simplifies the manufacturing process, potentially reducing production costs and improving the ease of vehicle integration.

The design of the modular hydrogen storage system prioritizes installation ease and operational flexibility. By eliminating the need for welding, the system reduces the time required for both installation and future maintenance. The use of adapter brackets for mounting the racks to various vehicle platforms ensures that the system can be adapted to a wide range of vehicle types with minimal modifications.

The ability of the modular hydrogen storage system to be customized for different vehicle platforms without permanent alterations is a significant advantage. It allows for the easy adjustment of fuel storage capacity to meet changing operational requirements or fuel needs.

The modular system not only facilitates customization but also simplifies the refueling process. Storage racks can be easily swapped out, allowing vehicles to quickly replace empty tanks with full ones, minimizing downtime. This feature is particularly beneficial for vehicles that operate on tight schedules, such as delivery vans and refuse collection trucks, where time efficiency is paramount.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a rack for multiple storage tanks, according to an embodiment of the present disclosure.

FIG. 2 is a top perspective view of the rack for multiple storage tanks of FIG. 1, depicted with the storage tanks removed.

FIG. 3 is a top perspective view of a system for holding racks for multiple storage tanks using multiple racks, according to an embodiment of the present disclosure.

FIG. 4 is an exploded, top perspective view of the system of FIG. 3.

FIG. 5 is a rear perspective of a vehicle depicted with the system of FIG. 3 loaded thereon.

FIG. 6 is a front perspective of another vehicle depicted with the system of FIG. 3 loaded thereon.

FIG. 7 is a flowchart illustrating a method of using a rack for a storage tank, according to an embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected, or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

The present technology relates to a rack and system for a storage tank, such as a hydrogen storage tank. The rack can be configured to removably mount to a platform of a vehicle. The rack can be configured to hold more than one storage tank and be coupled or connected to a second rack in a vertically stacked orientation using an alignment peg and an adapter bracket.

The present invention also relates to a modular storage tank system that can be deployed across multiple vehicle platforms. The system can include a rack. The rack can be configured to hold a storage tank. The rack can include a frame assembly. The frame assembly can include a base, an upright support member, and a strap connected to the frame assembly, where the strap can be configured to secure the storage tank on the frame assembly. The frame assembly can include more than one upright support member, as appropriately desired. For example, the frame assembly can include four upright support members. The base can include a Y-axis support member and an X-axis support member. The storage tank can sit across the Y-axis support member in a secured configuration. The rack can be configured to hold multiple storage tanks, as appropriately desired.

The upright support member includes an alignment peg and an adapter bracket. The alignment peg can be configured to removably fit within the adapter bracket of an additional rack for a storage tank, such that the rack for a storage tank and the additional rack for a storage tank can fit in a stacked configuration. The rack can include any appropriate desired number of alignment pegs and adapter brackets as appropriately desired. For example, the rack can include four alignment pegs and four adapter brackets.

The rack can be configured to removably mount to a platform of a vehicle. The Y-axis support member includes a form fitting slot for receiving the storage tank. The strap can be connected to the Y-axis support member at a first side of the strap and a second side of the strap. The frame assembly can be configured to hold more than one storage tank. The frame assembly can be configured to hold two storage tanks and each storage tank can be individually held by a strap. The strap can include a bungee portion to all for impact resistance where the system is affixed to a vehicle.

The present disclosure can also include a system for holding multiple storage tanks using multiple racks. For example, the system can include a first rack and a second rack. The second rack can be configured to fit onto a top of the first rack in a stacked configuration. One of the first rack and the second rack can be configured to removably mount to a platform of a vehicle. An alignment peg of the first rack can removably fit into an adapter bracket of the second frame assembly to connect the first rack and the second frame assembly in the stacked configuration. The alignment peg can include a hole configured to receive a locking pin, which can secure attached tanks to one another. It should be appreciated that a skilled artisan can implement any necessary securing means between the racks within the scope of the present disclosure. The system can include an appropriately desired number of racks mounted in a stacked configuration.

Each of the first rack and the second rack can include a frame assembly. The frame assembly can include a base, an upright support member, and a strap connected to the frame assembly, where the strap can be configured to secure a storage tank on the frame assembly. The base includes a Y-axis support member and an X-axis support member. The storage tank can sit across the Y-axis support member in a secured configuration. The first Y-axis support member of the first rack includes a first form fitting slot for receiving the first storage tank and the second Y-axis support member includes a second form fitting slot for receiving the second storage tank. Each of the first rack and the second rack can be configured to hold more than one storage tank. For example, each of the first rack and the second rack can be configured to hold two storage tanks.

The various components of the storage tank rack system can be manufactured from materials with requisite strength, durability, and compatibility with the stored substance (e.g., hydrogen). The frame assembly (e.g., base, upright support member can be manufactured from steel, which offers high strength and durability, commonly used in vehicle-related structures; aluminum, which is lightweight and corrosion-resistant, and suitable for reducing the overall weight of the vehicle; carbon fiber, which has high strength-to-weight ratio, though more expensive, and provides excellent rigidity and weight savings. A skilled artisan can select other suitable materials within the scope of the present disclosure.

The strap can be manufactured from nylon webbing, which is strong, durable, and resistant to abrasion, commonly used for securing loads; polyester webbing, which is similar to nylon but with better UV resistance, suitable for outdoor exposure; and Kevlar webbing, which offers high tensile strength and heat resistance, though more costly. A skilled artisan can select other suitable materials within the scope of the present disclosure.

The alignment peg and adapter bracket can be manufactured from stainless steel, which is corrosion-resistant and strong, ideal for components that require precision and durability; hardened steel, which offers high strength and wear resistance, suitable for parts that interlock or experience friction; and aluminum alloys, which are lightweight and can be treated for increased strength and corrosion resistance. A skilled artisan can select other suitable materials within the scope of the present disclosure.

The Y-axis and X-axis support members can be manufactured from steel tubing, which provides a strong and cost-effective option for structural components; aluminum extrusions, which are lightweight and can be designed with complex cross-sections for added strength where needed; composite materials, which can be tailored for specific load-bearing requirements. A skilled artisan can select other suitable materials within the scope of the present disclosure.

The form fitting slot can be manufactured from Rubber or Elastomeric Linings, which provide cushioning and reduce vibration for the storage tanks; polyurethane foam, which offers a snug fit and protection against impacts; high-density polyethylene (HDPE), which is durable and provides a low-friction surface for easy loading and unloading of tanks. A skilled artisan can select other suitable materials within the scope of the present disclosure.

Certain embodiments of the present disclosure can also include a vehicle. The vehicle can include a body. The body can comprise a semi-truck body including a semi-truck cab, a semi-truck bed disposed behind the semi-truck cab, and a plurality of wheels.

Embodiments can also include a rack platform mounted to the body. A rack can be removably received by the rack platform. The rack can be configured to hold a storage tank. The rack can include a frame assembly. The frame assembly can include a base, an upright support member, and a strap connected to the frame assembly, where the strap can be configured to secure the storage tank on the frame assembly. The base includes a Y-axis support member and an X-axis support member. The storage tank can sit across the Y-axis support member in a secured configuration.

Embodiments of the present disclosure can also relate to a method of using a rack. The rack can be configured to hold a storage tank. The method can include providing the rack. The rack can include a frame assembly. The frame assembly can include a base, an upright support member, and a strap connected to the frame assembly, where the strap can be configured to secure the storage tank on the frame assembly. The base includes a Y-axis support member and an X-axis support member. The storage tank can sit across the Y-axis support member in a secured configuration. The method can also include mounting the rack onto a vehicle.

Advantageously, with the present technology, a manufacturer can be able to fabricate a common base or base frame design on a repetitive basis, thus allowing for manufacturing optimization and cost reductions. The system can be mounted to a vehicle, such as a semi-truck platform using adapter brackets. In this manner, where the system and storage racks are used on a different vehicle platform, a different adapter bracket for the vehicle platform can be used with the technology of the present system and storage racks.

Because the present technology uses a modular design it can be deployed across many vehicle platforms. In addition, the present technology is scalable where multiple storage racks can be added or subtracted as appropriately needed. The design can be adaptable to larger and smaller pressure vessels by increasing and decreasing the system volume using different numbers of tanks. With the modular sub-system approach of the present technology, manufacturers can reduce the cost, minimize shipping costs (less volume and mass), and reduce the overall mass realized during vehicle integration. The modular design further allows for readily swapping out storage racks having empty or partially empty storage tanks with storage racks having full storage tanks or storage tanks having a greater amount of hydrogen. In this way, all or a portion of a multiple storage rack system can be changed, optimizing refueling of a vehicle employing such.

The technology can be applied to heavy-duty trucks, including semi-trucks and long-haul vehicles, to provide a scalable hydrogen storage solution that can be customized based on the range and payload requirements of the vehicle. Buses and coaches that utilize hydrogen fuel cells for power can benefit from the modular storage system, allowing for quick adaptation to different route lengths and passenger capacities.

Emergency vehicles such as fire trucks and ambulances can use the technology to maintain longer operational periods without the need for frequent refueling, which is critical in disaster response scenarios.

Ships and other maritime vessels can incorporate the modular hydrogen storage system to reduce emissions and comply with environmental regulations while ensuring sufficient energy storage for long voyages.

The technology can be adapted for use in the aerospace industry, where lightweight and robust hydrogen storage is crucial for various types of aircraft, including drones and potentially hydrogen-powered airplanes.

The modular system can be used to store hydrogen produced from renewable energy sources, such as wind or solar power, providing a means for energy storage and later use in power generation or transportation.

Forklifts, warehouse vehicles, and other material handling equipment that require clean energy sources can utilize the modular storage system for easy refueling and maintenance. Hydrogen-powered trains can benefit from the modular design, allowing for flexible storage capacity that can be adjusted based on the specific needs of different train routes and schedules.

Military vehicles that require a reliable and clean energy source in remote locations can use the modular hydrogen storage system to enhance operational range and reduce the logistics of fuel transport.

Heavy machinery used in mining and construction can integrate the storage system to reduce reliance on diesel fuel and lower carbon emissions, while providing the necessary energy for demanding tasks.

Tractors and other agricultural machinery that are transitioning to cleaner energy sources can adopt the modular hydrogen storage system to maintain productivity with reduced environmental impact. The technology can be used in stationary applications for backup power generation or in remote locations where grid power is unavailable, providing a clean and scalable power source.

### Implementations

Example implementations of the present technology are provided with reference to the several figures enclosed herewith.

### Application in Class 8 Semi-Trucks

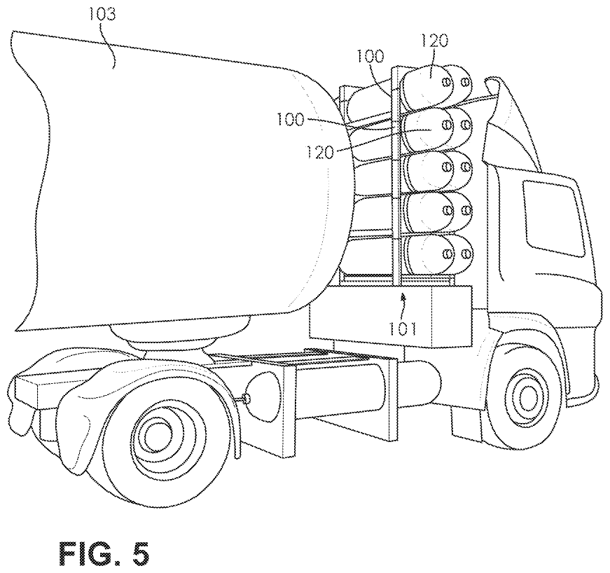

The modular hydrogen storage system is a versatile solution that can be customized for a variety of vehicle platforms, including Class 8 semi-trucks commonly used for long-haul transportation. These trucks require a robust hydrogen fuel storage system to accommodate the large volume of fuel necessary for extended trips without the need for frequent stops. The modular rack system includes a frame assembly that holds the hydrogen storage tanks securely with straps, for example, as shown in FIG. 5.

For the semi-truck application, the hydrogen storage needs are determined by the average distance the truck travels between refueling and its fuel consumption rate. The number of modular racks needed is calculated based on these requirements. Each rack can hold multiple storage tanks, and the racks can be stacked both vertically and horizontally, allowing customization in both height and width to fit the designated storage area of the truck.

The assembly process involves loading the storage tanks onto the racks and securing them with the provided straps. The racks are then arranged in the desired configuration, either stacked on top of each other or side by side, to form the complete hydrogen storage system. This system is then installed onto the rack platform of the semi-truck, ensuring stability and safety during transport.

### Adaptation to Medium-Duty Delivery Vans

Medium-duty delivery vans, which are smaller than semi-trucks and require efficient use of space, also benefit from the modular hydrogen storage system. These vans need a compact hydrogen storage solution that does not compromise cargo space. The scalability allows for a reduction in the number of racks and storage tanks to fit the size constraints of the van.

For delivery vans, the hydrogen fuel needs are assessed based on typical delivery routes and the number of stops expected. The modular system can be configured to fit within the space limitations of the van, using fewer racks in a single-layer or a reduced stacked arrangement. The installation process mirrors that of the semi-truck, with the system being secured to the specific mounting points in the van using adapter brackets.

Integration into Refuse Collection Trucks

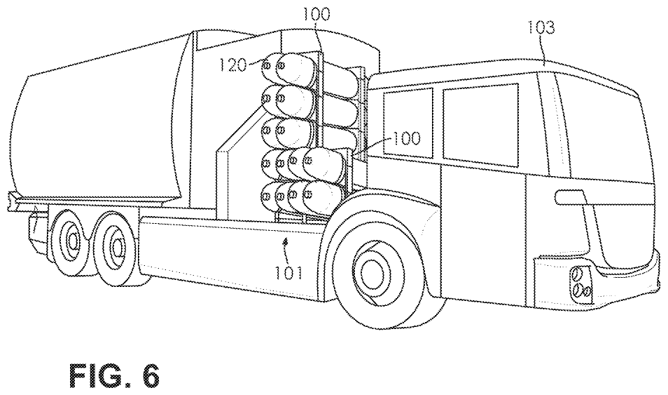

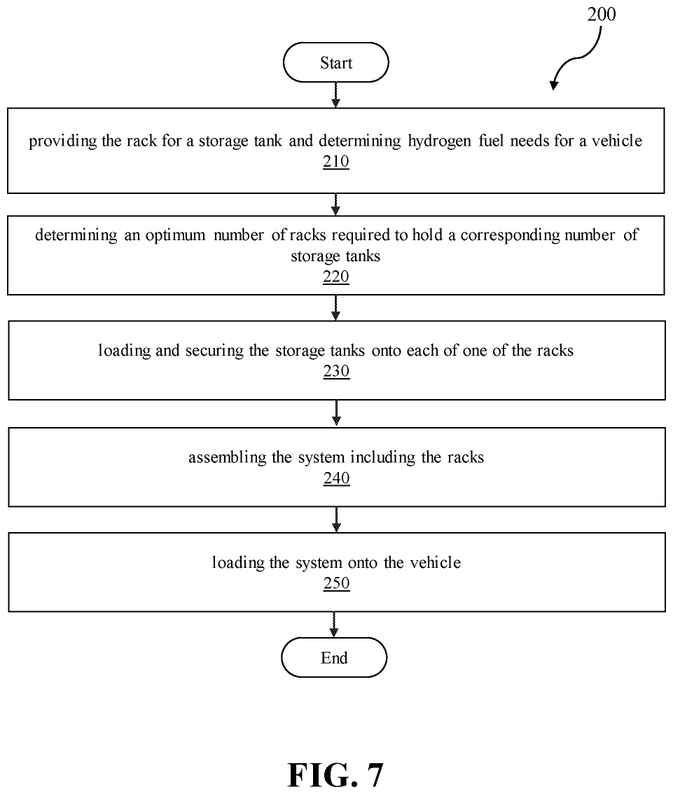

Refuse collection trucks present a unique set of requirements for hydrogen storage due to their stop-and-go nature and the need to balance fuel storage with waste capacity. The ability to be customized in both the vertical and horizontal planes allows for a tailored fit that maximizes operational efficiency, for example, as shown in FIG. 6.

The fuel needs for refuse collection trucks are based on the daily collection routes and the frequency of stops. The modular racks can be arranged to fit the available space on the truck, ensuring that the hydrogen storage does not impede the waste collection and compaction mechanisms. The racks can be installed in a configuration that optimizes the center of gravity, which is crucial for the stability of these frequently stopping and starting vehicles.

In all three applications, the modular hydrogen storage system is adaptable to different vehicle types and operational needs. It provides a scalable and customizable solution that supports the transition to hydrogen-powered transportation across various sectors. The system facilitates easy swapping and rearranging of storage racks, which enhances the operational efficiency of the vehicles it serves.

### EXAMPLES

Example embodiments of the present technology are provided with reference to the several figures enclosed herewith.

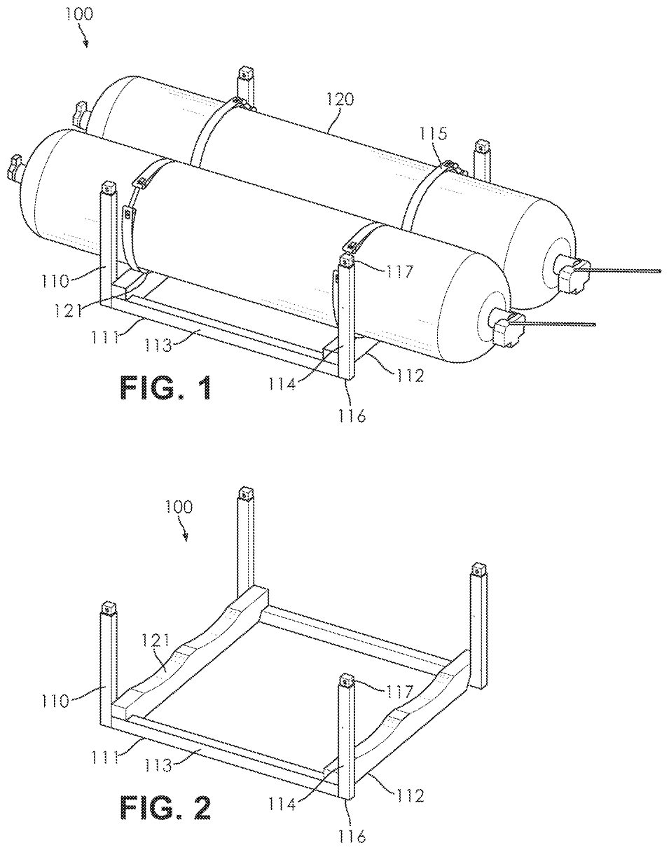

FIGS. 1-2 describe a rack 100, according to some embodiments of the present disclosure. The rack 100 can be configured to removably hold a storage tank 120, such as a hydrogen storage tank. The rack 100 can include a frame assembly 110. The frame assembly 110 can include a base 111 and an upright support member 114. The base 111 can include multiple upright support members 114 as appropriately desired. The frame assembly 110 can also include a strap 115 connected to the frame assembly 110, where the strap 115 can be configured to secure the storage tank 120 on the frame assembly 110. The base 111 can include a Y-axis support member 112. The base 111 can also include an X-axis support member 113, where the storage tank 120 sits across the Y-axis support member 112 in a secured configuration.

The Y-axis support member 112 can include a form fitting slot 121 for receiving the storage tank 120. For example, the form fitting slot 121 can include a surface complementary to a surface of the storage tank 120. The strap 115 can be connected to the Y-axis support member 112 at a first side of the strap 115 and a second side of the strap 115. The frame assembly 110 can be configured to hold more than one storage tank 120. The frame assembly 110 can be configured to hold two storage tanks 120. Each storage tank 120 can be individually held by one or more straps 115.

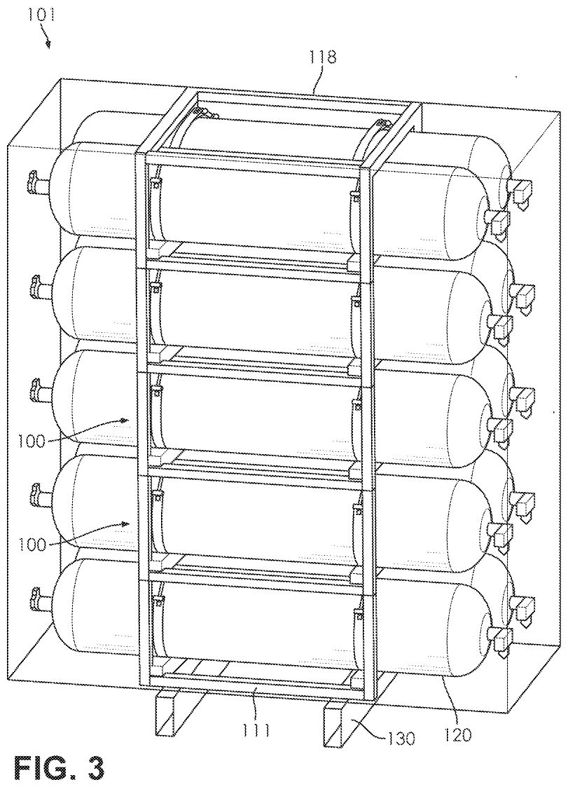

The upright support member 114 can include an alignment peg 117 and an adapter bracket 116. The alignment peg 117 can be configured to removably fit within the adapter bracket 116 of a second rack 110; e.g., as shown in FIG. 3, such that the rack 100 and the second rack 110 rack can connect in a stacked configuration.

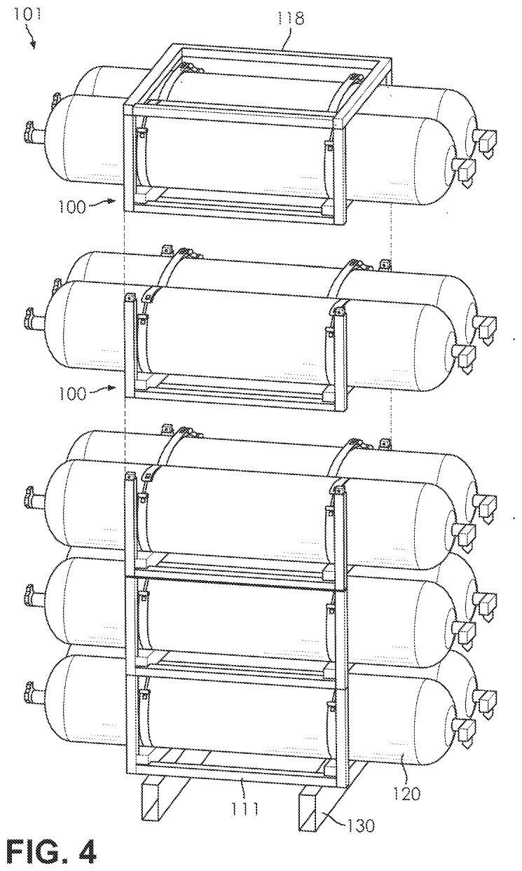

FIGS. 3-4 show a system 101 for holding more than one rack 100 and storage tank 120 according to some embodiments of the present disclosure. The system 101 can include a rack 100 and a second rack 100 disposed on a top of the rack 100. Each of the rack 100 and the second rack 100 can be configured to removably hold a storage tank 120. The second rack 100′ can be similar to the rack 100, such as shown in FIG. 1. The embodiment depicted in FIG. 3 shows a stack of five such racks 100.

The rack 100 and the second rack 100 can each comprise include a frame assembly 110. The frame assembly 110 can include a base 111 and an upright support member 114. The frame assembly 110 can also include a strap 115 connected to the frame assembly 110, where the strap 115 can be configured to secure the storage tank on the frame assembly 110. The base 111 can include a Y-axis support member 112. The base 111 can also include an X-axis support member 113, where the storage tank sits across the Y-axis support member 112 in a secured configuration.

An alignment peg 117 of the first rack 100 removably fits into an adapter bracket 116 of the second rack 100 to connect the first rack 100 to the second rack 100. The first rack 100 can be removably connected to rack platform mounted on a vehicle. Each rack 100 can be configured to hold more than one storage tank 120. A top 118 of the system 101 can secure each of the racks 100 and each storage tank 120. For example, the top 118 can include an adapter bracket 116 configured to fit into an adapter bracket 116 of a rack 100 of the system 101, such that the top 118 fits over and onto the rack 100 to secure each of the racks 100 and each storage tank 120.

FIG. 5 depicts the system 101 installed on a semi-truck, in particular, on a rack platform behind a semi-truck cab. The rack platform can be configured to receive the rack 100, such as described above. In particular, the rack platform can be configured to hold a rack 100 and a second rack 100, such as described above. In particular, the rack platform can be configured to hold any appropriately desired number of racks 100.

It should be appreciated that the racks 100 can be secured to the vehicle by various means known in the art. As non-limiting examples, bolts and nuts, locking pins, anchor plates, U-bolts, and clamps can be selected to secure the racks 100 to the vehicle within the scope of the present disclosure. However, it should also be appreciated that the system can be attached to the vehicle by mechanical means. It is not necessary to permanently affix the system to the vehicle. In particular, it may not be necessary to weld the system to the vehicle.

FIG. 6 is a flowchart that describes a method 200 of using the rack 100 and the system 101. At 210, the method 200 can include determining the hydrogen fuel needs and volume availability for a specific vehicle 103 (e.g., the semi-truck shown in FIG. 5). This can include determining the necessary amount of fuel tanks 120 to be loaded onto the vehicle 103. At 220, the method 200 can include a step of determining an optimum number of racks 100 to hold the tanks 120 based on the fuel needs determined in step 210.

At 230, the method 200 can include loading the racks 100 of the system 101. In particular, based on the number of racks determined from the step 220, the racks 100 can be assembled and loaded with storage tanks 120. The tanks 120 can be placed onto each of the racks 100. At 240, the method can include securing the tanks. The straps 115 connected to can be drawn over each of the tanks 120 and then tightened to secure each tank 120 individually to the rack 100.

At 240, the method 200 can include assembling the racks 100. Once each of the racks 100 is loaded, the racks 100 can be assembled or otherwise stacked. This step can be repeated until the system 101 is fully assembled for loading onto the vehicle 101.

At 250, the method can include loading the system 101 onto the vehicle. The stacked racks 100 can positioned onto the semi-truck bed. The racks 100 can be secured to the platform of the vehicle via bolts or locking pins, as non-limiting examples.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A rack for a storage tank, comprising:
a frame assembly including a base, an upright support member, and a strap connected to the frame assembly, where the strap is configured to secure the storage tank on the frame assembly; and
the base including a Y-axis support member and an X-axis support member, where the storage tank sits across the Y-axis support member in a secured configuration.

2. The rack for a storage tank of claim 1, wherein the upright support member includes an alignment peg and an adapter bracket.

3. The rack for a storage tank of claim 2, wherein the alignment peg is configured to removably fit within the adapter bracket of another rack for a storage tank, such that the rack for a storage tank and the another rack for a storage tank can connect in a stacked configuration.

4. The rack for a storage tank of claim 2, wherein the adapter bracket is configured to removably mount to a rack platform of a vehicle.

5. The rack for a storage tank of claim 1, wherein the Y-axis support member includes a form fitting slot for receiving the storage tank.

6. The rack for a storage tank of claim 1, wherein the strap is connected to the Y-axis support member at a first end of the strap and a second end of the strap.

7. The rack for a storage tank of claim 1, wherein the frame assembly is configured to hold more than one storage tank.

8. The rack for a storage tank of claim 1, wherein a hydrogen storage tank is disposed on the rack and secured by the strap.

9. The rack for a storage tank of claim 1, wherein the frame assembly includes four upright support members.

10. The rack for a storage tank of claim 3, wherein the rack includes four alignment pegs and four adapter brackets.

11. A system for holding multiple storage tanks comprising:
a first rack for a storage tank and a second rack for a storage tank, wherein each of the first rack for a storage tank and the second rack for a storage tank include:
a frame assembly including a base, an upright support member, and a strap connected to the frame assembly, where the strap is configured to secure the storage tank on the frame assembly; and where the base includes a Y-axis support member and an X-axis support member, where the storage tank sits across the Y-axis support member when the strap secures the storage tank on the frame assembly.
wherein the second rack is connected to a top of the first rack, such that the first rack and the second rack are connected in a stacked configuration.

12. The system for holding multiple storage tanks of claim 11, wherein an alignment peg of the first rack for a storage tank removably fits into an adapter bracket of the second rack for a storage tank to connect the first rack for a storage tank and the second rack for a storage tank.

13. The system for holding multiple storage tanks of claim 12, wherein the first rack for a storage tank is removably connected to rack platform mounted on a vehicle.

14. The system for holding multiple storage tanks of claim 11, wherein the first rack for a storage tank and the second rack for a storage tank are configured to hold more than one storage tank.

15. The system for holding multiple storage tanks of claim 11, wherein a hydrogen storage tank is disposed on the first rack and secured by the strap.

16. The system for holding multiple storage tanks of claim 11, further comprising a third rack for a storage tank rack connected to a top of the second rack for a storage tank, such that the first rack for a storage tank, the second rack for a storage tank and the third rack for a storage tank are connected in a stacked configuration.

17. A vehicle, comprising:
a body;
a rack platform mounted to the body; and
the rack of claim 1.

18. The vehicle of claim 17, wherein a hydrogen tank is disposed on the rack and secured with the strap.

19. The vehicle of claim 17, wherein the vehicle comprises a semi-truck.

20. A method of using a rack for a storage tank, comprising:
providing the rack for a storage tank, wherein the rack for a storage tank includes a frame assembly including a base, an upright support member, and a strap connected to the frame assembly, where the strap is configured to secure the storage tank on the frame assembly, wherein the base further includes a Y-axis support member and an X-axis support member, where the storage tank sits across the Y-axis support member in a secured configuration;
determining hydrogen fuel needs for a vehicle;
determining a number of racks required to hold a corresponding number of storage tanks based on the determined hydrogen fuel needs;
loading the storage tanks onto each of one of the racks;
securing each of the storage tanks to the rack;
assembling the racks in a stacked configuration to form a hydrogen storage system;
positioning the assembled hydrogen storage system onto vehicle; and
securing the hydrogen storage system to the vehicle.
